(19) United States
(12) Patent Application Publication
(10) Pub. No.: US 2020/0186690 A1
(43) Pub. Date: Jun. 11, 2020

(54) IMAGING CONTROL APPRATUS, IMAGING CONTROL METHOD, AND STORAGE MEDIUM

(71) Applicant: CANON KABUSHIKI KAISHA, Tokyo (JP)

(72) Inventor: Yoichi Kodama, Yokohama-shi (JP)

(21) Appl. No.: 16/686,592

(22) Filed: Nov. 18, 2019

(30) Foreign Application Priority Data
Dec. 6, 2018 (JP) 2018-228701

(51) Int. Cl. H04N 5/225; G06T 7/70; G06T 7/80; H04N 5/232; H04N 7/18

(52) U.S. Cl. CPC H04N 5/2259; G06T 7/70; G06T 7/80; H04N 5/23296; H04N 5/232123; G06T 2207/10016; H04N 7/183; H04N 5/23216; H04N 5/23299; G06T 2207/30244; G06T 2207/30232; H04N 5/23203

(57) ABSTRACT

To shorten an operation time for a tilt angle and to avoid unintentional changing of the tilt angle to an improper tilt angle, an imaging control apparatus for controlling a camera limits a tilt angle based on an installation direction of the camera and information stored in a memory, wherein the information relates to the limitation of the tilt angle corresponding to respective installation direction of the camera.

### BACKGROUND OF THE INVENTION

### Field of the Invention

The present invention relates to an imaging control apparatus, an imaging control method and a storage medium.

### Description of the Related Art

Surveillance cameras are often installed at high places and optical axes thereof are directed obliquely downward to observe pedestrians on a road, cars or license plate thereof. In this situation, since the optical axes of the cameras are directed obliquely downward, and focusing planes that are focused in imaging are perpendicular to the optical axes, the focusing planes does not coincide with a plane of an object to be imaged. Therefore, the depth of focusing zone (depth of field) corresponds to only a part of an image frame and the other part of the image frame is blurred.

To solve this problem, it is known that by narrowing an aperture of an optical system for deepening the depth of field, blurring can be reduced to some extent. However, surveillance cameras are often used under low light condition, where it is often necessary to open the aperture to the maximum. As a result, the depth of field become narrow so that proper focusing cannot be obtained throughout the entire image frame and some part of the image frame become still blurred.

To cope with the above problem, there is a method of tilting an optical lens with respect to an image sensor to deepen the depth of field. On the contrary, there is also a method of tilting an image sensor with respect to an optical lens to deepen the depth of field. Both ways are to be called ‘tilting_ hereafter. In the following embodiment, ‘tilting_ by the image sensor is representatively explained but ‘tilting_ may be realized by tilting at least one of the optical lenses and the image sensors with respect to the other.

By applying this ‘tilting_ to surveillance cameras, the depth of field becomes wider even when the aperture is fully open so that surveillance cameras can monitor from near to distance with proper focusing.

When tilting the image sensor using step motors, a tilt angle par one pulse is determined by an amount of rotation of the step motor and a gear ratio.

Therefore, the tilt angle of the image sensor with respect to the lens can be designated by a number of pulses so that necessary tilt angle of the image sensor can be obtained.

Here, one of axes of tilting may be an axis which is parallel to a long side of the image sensor and which passes through a center of the image sensor. This is called a vertical tilting. Another of axes of tilting may be an axis which is parallel to a short side of the image sensor and which passes through a center of the image sensor. T his is called a horizontal tilting. Other axes may be possibly adopted.

In Japanese laid open patent publication No. 2008-205569 discloses that by detecting an attitude of an image sensor, it is determined which side of the image sensor is parallel to the absolute horizon. And depending on the result, an axis for tilting is selected so that the horizontal tilting or the vertical tilting is selected. Therefore, if the long side is parallel to the absolute horizon, then by selecting the horizontal tilting, only a certain object can be focused to obtain a portrait photography effect.

In addition, in Japanese laid open patent publication No. 2008-028591, an image sensor is relatively tilted so that the nearest object is focused at an upper portion of an image sensor and the furthest object is focused at a lower portion of an image sensor.

And depending a distance to each object, edge enhancement is adjusted. In addition, an attitude of a camera is detected and based on the attitude of the camera, the image sensor is relatively tilted so that the furthest object is always focused at the lower portion of the image sensor.

Although the Japanese laid open patent publication No. 2008-205569 discloses that an axis and direction of the tilting is determined based on an attitude of the image sensor, an angle of the tilting is not properly limited.

Although the Japanese laid open patent publication No. 2008-028591 discloses that an axis of the tilting is determined based on an attitude of the camera, a direction of the tilting is not properly determined.

One of objects of the present invention is to provide an imaging apparatus that is able to properly limit the tilt angle depending on a direction of camera installation so that improper operation for tilting can be prevented and an operation time for proper tilting is shortened.

### SUMMARY OF THE INVENTION

According to an aspect of the present invention, there is provided an imaging control apparatus that controls an imaging apparatus including an imaging unit for taking an object image through an optical system, comprising:

a controller having a processor which executes instructions stored in a memory or having circuitry, the controller being configured to function as:

a tilt control unit configured to control a tilt angle between the imaging unit and the optical system;

a determination unit configured to determine an installation direction of the imaging apparatus;

a data storage unit configured to store information relating to a limitation of the tilt angle corresponding to respective installation direction of the imaging apparatus; and

wherein the tilt control unit limits the tilt angle based on the installation direction of the imaging apparatus acquired by the determination unit and the information relating to the limitation of the tilt angle corresponding to respective installation direction of the imaging apparatus stored in the data storage unit.

Further features of the present invention will become apparent from the following description of exemplary embodiments with reference to the attached drawings.

### BRIEF DESCRIPTION OF THE DRAWINGS

FIG. 1 is a diagram illustrating a configuration of a system including a surveillance camera according to an embodiment.

FIG. 2 is a block diagram and a system configuration illustrating the surveillance camera and a control apparatus according to the embodiment.

FIG. 3 is a schematic sectional view illustrating a vertical tilting when viewed from a left hand side of the surveillance camera.

FIG. 4 is a schematic sectional view illustrating a horizontal tilting when viewed from a top side of the surveillance camera.

FIG. 5 is a flowchart illustrating an operation of limiting the tilt angle according to the embodiment.

FIG. 6 is a chart illustrating data relating to limitations corresponding to each of installation directions according to the embodiment.

FIG. 7 is a flowchart illustrating an automatic operation for controlling the tilt angle according to the embodiment.

FIG. 8 is a diagram illustrating the Scheimpflugs̆ principle.

### DESCRIPTION OF THE EMBODIMENTS

Hereinafter, an imaging apparatus according to embodiments of the present invention will be described with reference to the drawings. Here, the same reference numerals are given to units that have the same functions throughout the drawings and repeated description thereof will be omitted.

### <Network Configuration>

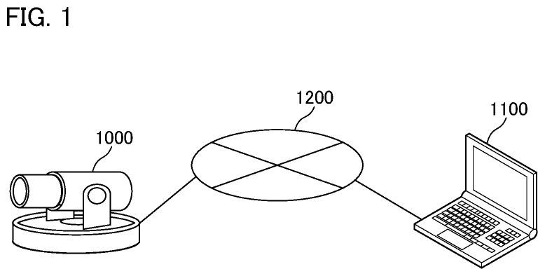

FIG. 1 is a diagram illustrating a network configuration of a system including a surveillance camera according to an embodiment.

In FIG. 1, reference numeral 1000 denotes a surveillance camera as an imaging apparatus, reference numeral 1100 denotes a control apparatus for controlling the surveillance camera 1000 and reference numeral 1200 denotes a network. The surveillance camera 1000 and the control apparatus 1100 are connected via the network 1200 so that bidirectional transmission between the surveillance camera 1000 and the control apparatus 1100 is possible.

The control apparatus 1100 sends various commands to the surveillance camera 1000 and the surveillance camera 1000 sends back respective responses corresponding to the commands to the control apparatus 1100.

### <Surveillance Camera>

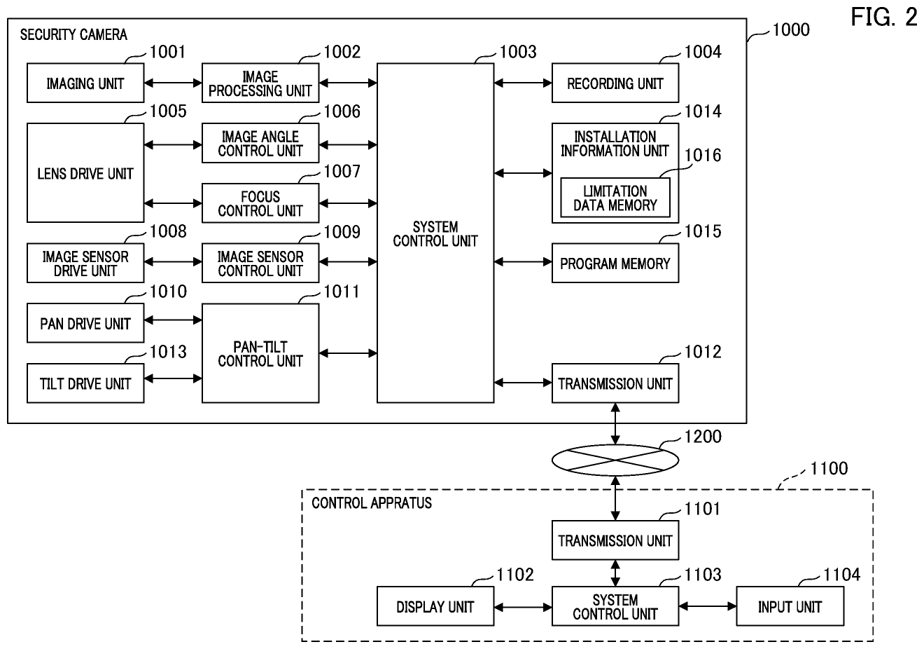

FIG. 2 is a block diagram and a system configuration illustrating the surveillance camera and a control apparatus according to the embodiment. In FIG. 2, reference numeral 1001 denotes an imaging unit, reference numeral 1002 denotes an image processing unit, reference numeral 1003 denotes a system control unit that includes a CPU working as a computer.

The CPU executes variety of operations according to a computer program stored in a program memory 1015. Reference numeral 1004 denotes a recording unit, reference numeral 1005 denotes a lens drive unit, and reference numeral 1006 denotes an image angle control unit.

Reference numeral 1007 denotes a focus control unit, reference numeral 1008 denotes an image sensor drive unit, and reference numeral 1009 denotes an image sensor control unit. Reference numeral 1010 denotes a pan drive unit, reference numeral 1011 denotes a pan-tilt control unit, reference numeral 1012 denotes a transmission unit, and reference numeral 1013 denotes a tilt drive unit for tilting a direction of the surveillance camera 1000.

The imaging unit 1001 includes an image sensor that photoconverts an optical image passed through an optical system including lenses (not illustrated in FIG. 2) to an electrical signal.

The image processing unit 1002 applies a predetermined signal processing, an image inversion processing, a compression encoding processing, and so on to the electrical signal photoconverted by the imaging unit 1001 so as to generate vide data. Here, the image inversion processing includes rotation processing of 90 degrees, 180 degrees, and 270 degrees.

The system control unit 1003 analyses camera control commands sent from the control apparatus 1100 to executes corresponding processing.

One of the corresponding processing includes sending the video data to the control apparatus through the transmission unit 1012 in response to receiving a command that requests a live video signal.

In addition, the system control unit 1003 receives commands that request a zoom value, a focus value, a tilt angle value, a signal inversion value, a pan-tilt value, and so on from the control apparatus.

The system control unit 1003 acquires those values from the image processing unit 1002, the image angle control unit 1006, the focus control unit 1007, the image sensor control unit 1009, the pan-tilt control unit 1011, and so on, then send the values to the control apparatus 1100 through the transmission unit 1012.

The system control unit 1003 also receives commands for setting the zoom, the focus, the tilt angle, the image inversion, the pan-tilt, and so on. And when the system control unit 1003 receives one of them, controls corresponding one of the image processing unit 1002, the image angle control unit 1006, the focus control unit 1007, the image sensor control unit 1009, the pan-tilt control unit 1011, and so on, according to the command for setting.

That is, the system control unit 1003 sends commands the above mentioned units so as to actuate the lens drive unit 1005, the imaging sensor drive unit 1008, the pan drive unit 1010, the tilt drive unit 1013, and so on according to the command for setting. As such, the values for setting the zoom, the focus, the tilt angle, the image inversion, the pan-tilt, and so on are applied to the surveillance camera 1000.

The recording unit 1004 stores video data and variety of data in an internal memory or an external memory.

The image angle control unit 1006 sends a command for changing a zoom lens position (zoom ratio) to the lens drive unit 1005 according to a zoom value transmitted from the control apparatus 1003.

The focus control unit 1007 sends a command for changing a focus lens position (focus adjustment) to the lens drive unit 1005 according to a focus value transmitted from the control apparatus 1100.

Here, focus modes of the surveillance camera 1000 include a manual mode, an auto-focus (hereinafter referred to as AF) mode, an infinite mode, an one-shot AF mode, and so on. The manual mode is a mode that a user manually controls the focus lens position. The auto-focus mode is a mode that the surveillance camera 1000 automatically controls the focus lens position so that, for example, a center area of an image frame is being focused. The infinite mode is a mode that the surveillance camera 1000 sets the focusing lens to a predetermined fixed lens position for focusing an object at an infinite distance.

The infinite mode is mainly used for focusing a distant object or a distant background while a near object is blurred. The one-shot AF mode is a mode that, during the manual mode, the surveillance camera performs AF once and thereafter the focus mode returns to the manual mode.

In the AF mode, for example, a contrast detection method may be used for AF, where the focus control unit 1007 send a command to discretely change the focus lens position with a predetermined pitch. At the same time, the focus control unit 1007 obtains the video data from the image processing unit 1002 and acquires contrast evaluation values of an area to be focused in the image frame. By this process, the focus control unit 1007 can obtain a table including contrast evaluation values corresponding to each of the discrete focus lens position so that a focus lens position corresponding to a maximum contrast value can be determined.

The image sensor control unit 1009 sends a command for changing the tilt angle to the image sensor drive unit 1008 according to a tilt angle value transmitted from the control apparatus 1100.

The pan-tilt control unit 1011 sends a command for changing the pan-tilt condition to the pan drive unit 1010 and the tilt drive unit 1013 according to a pan value and a tilt value transmitted from the control apparatus 1100.

The transmission unit 1012 sends the video data to the control apparatus 1100 through the network 1200. In addition, the transmission unit 1012 receives variety of commands from the control apparatus 1100 and transit them to the system control unit 1003.

The commands sent from the control apparatus 1100 includes a command requesting sending live video data, commands requesting sending current values of the zoom, the focus, the tilt angle, the installation direction, and pan-tilt condition, and commands requesting changing those values of the surveillance camera 1000.

The lens drive unit 1005 includes motors and a driving mechanism for driving a focus lens and a zoom lens included in the optical system, and is controlled by the image angle control unit 1006 and the focus control unit 1007.

The pan drive unit 1010 includes motors and a driving mechanism for performing a pan operation and is controlled by the pan-tilt control unit 1011.

The tilt drive unit 1013 includes motors and a driving mechanism for performing a tilt operation and is controlled by the pan-tilt control unit 1011.

An installation information unit 1014 manages information relating to the camera installation direction, proper tilt angles corresponding to the camera installation direction, and so on. The installation information unit 1014 includes a limitation data memory 1016 as a limitation data storing unit, where data relating to limitations (proper range) of the tilt angles is stored.

### <Control Apparatus>

The control apparatus 1100 may be typically in a form of a personal computer or a general purpose computer.

A transmission unit 1101 transmits variety of commands issued by the control apparatus 1100 to the surveillance camera 1000.

The commands sent to the surveillance camera 1000 include a command requesting live video data, commands requesting sending current values of the zoom, the focus, the tilt angle, the installation direction, and pan-tilt condition, and commands requesting changing those values of the surveillance camera 1000.

In addition, the transmission unit 1101 receives the video data and variety of data sent from the surveillance camera.

The data received from the surveillance camera 1000 include live video data, current values of the zoom, the focus, the tilt angle, the installation direction, a pan-tilt condition, and so on of the surveillance camera 1000.

A display unit 1102, which may include a liquid crystal display apparatus, displays the video data received from the surveillance camera 1000 and a GUI for controlling the camera.

A system control unit 1103 executes variety of operations based on a computer program stored in a program memory (not illustrated) in the control apparatus. For example, the system control unit 1103 generates a camera control command in response to a user operation via the GUI, and transmits the camera control command to the surveillance camera 1000 through the transmission unit 1101.

In addition, the system control unit 1103 controls the display unit 1102 to display the video data, variety of data including values of the zoom, the focus, the tilt angle, the installation direction, a pan-tilt condition, and so on received from the surveillance camera 1000 via the transmission unit 1101.

A input unit 1104 includes a keyboard, a pointing device such as a mouse or a touch panel so that users of the control apparatus 1100 can operate the GUI with the input unit 1104.

### <Vertical Tilting>

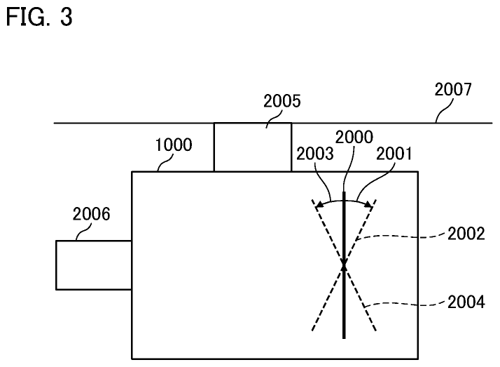

FIG. 3 is a schematic sectional view illustrating a vertical tilting when viewed from a left hand side of the surveillance camera.

Reference numerals 2000, 2002 and 2004 denote inclinations corresponding to respective tilt angle of the image sensor in a vertical direction. Reference numeral 2000 denotes an initial position corresponding to the tilt angle at 0 degrees.

Changing from the inclination 2000 to the inclination 2002 (direction of a clockwise arrow 2001) is referred to as an up tilting.

Changing from the inclination 2000 to the inclination 2004 (direction of a counterclockwise arrow 2003) is referred to as a down tilting.

Reference numeral 2005 denotes a mounting unit for mounting the surveillance camera 1000 to, for example, a ceiling. Reference numeral 2006 denotes a lens barrel.

In FIG. 3, the surveillance camera 1000 is mounted to the ceiling with the mounting unit 2005 without changing an attitude of the surveillance camera 1000 from a normal attitude. This installation direction of the camera is referred to as a normal (installation) direction.

Conversely, if the surveillance camera 1000 is mounted to the ceiling upside down (not illustrated), that installation direction of the camera is referred to as a reverse (installation) direction.

When the surveillance camera 1000 is mounted to the ceiling upside down, that is, when the installation direction is a reverse direction, the video data is to go through the inversion process in the image processing unit 1002 to be rotated by 180 degrees.

Here, suppose that the surveillance camera 1000 is mounted to the ceiling in a normal installation direction and views diagonally downward to image from a near object such as a ground or a floor to a far distant object, which is hereinafter referred to as a use case 1. In this situation (use case 1), the up tilting can be used to focus at both near and distance, which is known as the Scheimpflugs̆ principle.

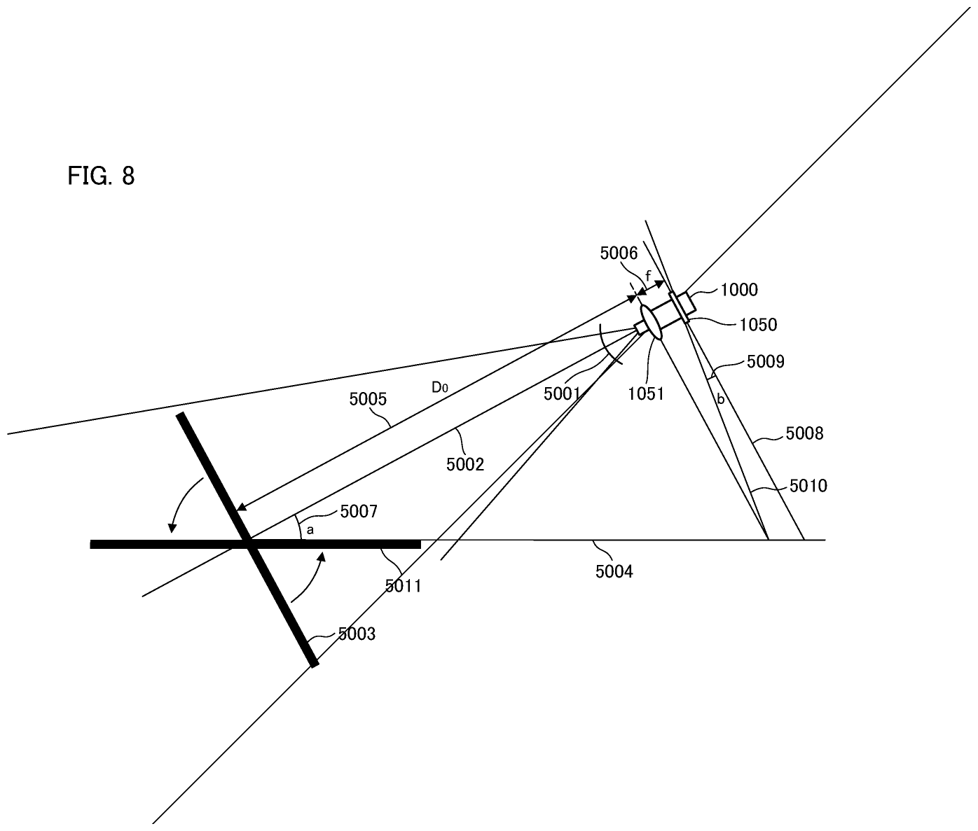

FIG. 8 is a diagram illustrating the Scheimpflugs̆ principle. In FIG. 8, the surveillance camera 1000 including an image sensor 1050 and a lens 1051, which is a part of the optical system, views an image angle of 5001. Reference numeral 5002 denotes an optical axis of the lens 1051, and reference numeral 5003 denotes a focus position, that is a focus plane, where the focus plane is perpendicular to the optical axis 5002. FIG. 8 shows an example in which a center of the focus plane is on a ground 5004.

In FIG. 8, reference numeral 5005 (Do) denotes a distance between the camera and an object that is focused, reference numeral 5006 (f) denotes a distance between the lens and the image sensor, and reference numeral 5007 (a) denotes an installation angle of the surveillance camera 1000.

In FIG. 8, reference numeral 5008 denotes an image sensor plane when the tilting is not applied. Reference numeral 5010 denotes an image sensor plane when the plane 5008 is inclined by a tilt angle 5009 (b), and reference numeral 5011, which is to coincide with the ground 4, denotes a focus plane at that time.

As explained in the above, when the image sensor plane 5008 is inclined to 5010, the tilt angle 5009 (b) is expressed by an equation (1) according to the Scheimpflugs̆ principle.

b=arctan(f/(Do tan a))\check{u} (1)

That is, the tilt angle 5009 (b) is calculated based on the distance 5005 (Do) to an object and the installation angle 5007 (a) of the camera 1000.

In this situation, if the camera is installed in the reverse (installation) direction, the down tilting should be applied to the camera to focus at both near and distance.

### <Horizontal Tilting>

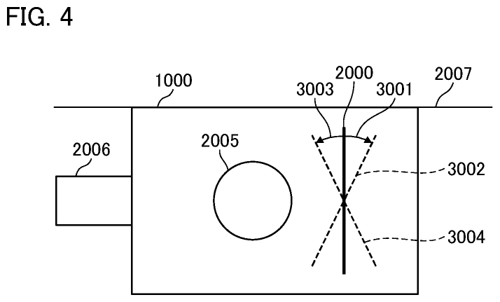

FIG. 4 is a schematic sectional view illustrating a horizontal tilting when viewed from a top side of the surveillance camera 1000.

Reference numerals 2000, 3002 and 3004 denote inclinations corresponding to respective tilt angle of the image sensor in a horizontal direction. Reference numeral 2000 denotes an initial position corresponding to the horizontal tilt angle at 0 degrees.

Changing from the inclination 2000 to the inclination 3002 (direction of a clockwise arrow 3001) is referred to as a right tilting.

Changing from the inclination 2000 to the inclination 3004 (direction of a counterclockwise arrow 3003) is referred to as a left tilting.

In FIG. 4, the surveillance camera 1000 is mounted to the ceiling with a right side of the surveillance camera 1000 being mounted to the ceiling 2007. This installation direction is referred to as a direction of right side up.

Conversely, if a left side of the surveillance camera 1000 is mounted to the ceiling 2007 (not illustrated), that installation direction is referred to as a direction of left side up.

When the surveillance camera 1000 is mounted to the ceiling in the direction of left side up, the video data is to go through the inversion process in the image processing unit 1002 to be rotated by 90 degrees or 270 degrees.

In the above use case 1, if the camera is installed in the direction of right side up, and if the right tilting is applied, wide focusing from near to distance is realized. And if the camera is installed in the direction of left side up, and if the left tilting is applied, wide focusing from near to distance is realized.

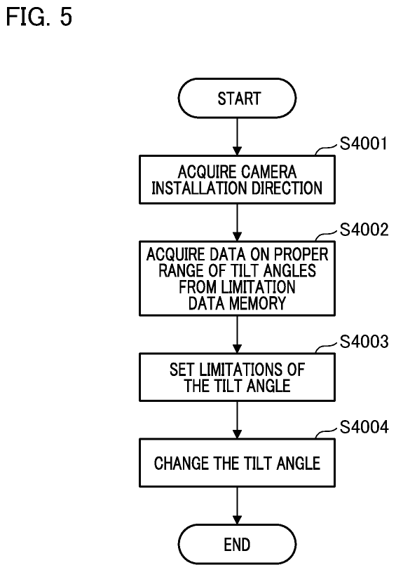

FIG. 5 is a flowchart illustrating an operation of limiting the tilt angle according to the embodiment.

In step S4001, the installation information unit 1014 acquires the camera installation direction such as the normal direction, the reverse direction, and so on based on, for example, a value on the image rotation that is inputted to the system control unit 1003 from the control apparatus 1100 when a user operates the input unit 1104.

That is, the installation information unit 1014 acquires the value on the image rotation inputted by the user from the image processing unit 1002 via the system control unit 1003, and the installation information unit 1014 determines the camera installation direction based on the value on the image rotation.

For example, if the value on the image rotation is 0 degrees (without rotation), then it is determined that the camera installation direction is (assumed to be) the normal direction, while if the value on the image rotation is 180 degrees, then it is determined that the camera installation direction is (assumed to be) the reverse direction.

If the value on the image rotation is 90 degrees, then it is determined that the camera installation direction is (assumed to be) the direction of right side up. If the value on the image rotation is 270 degrees, then it is determined that the camera installation direction is (assumed to be) the direction of left side up.

Another example is that the system control unit 1003 may recognize an object such as a human or a car in the video data obtained from the image processing unit 1002 by an image recognition to determine directions of the object in an image frame, and the installation information unit 1014 may determine the camera installation direction based on the directions of the object in the image frame.

Still another example is that data on the camera installation direction may be inputted and stored in the camera by a user when the camera is installed.

Still another example is that the surveillance camera may include a gravity sensor, and the installation information unit 1014 may determine the camera installation direction based on an output of the gravity sensor.

In step S4002, the system control unit 1003 acquires the data relating to limitations of the tilt angles from the limitation data memory 1016. The data relating to limitations of the tilt angles includes proper ranges of the tilt angles corresponding to each of the camera installation directions.

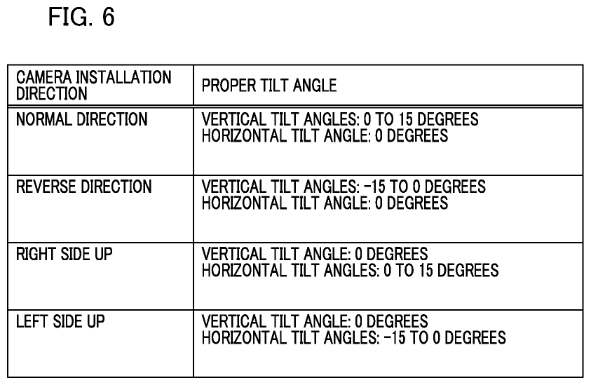

FIG. 6 is a chart illustrating the data relating to limitations (proper range) of the tilt angle, which is stored in the limitation data memory 1016, corresponding to each of the camera installation directions according to the embodiment.

In FIG. 6, the left column illustrates the camera installation directions and the right column illustrates the limitations (proper range) of the tilt angle corresponding to the installation directions at left column.

H ere, the limitations (proper range) of the tilt angle shown in FIG. 6 are examples suitable to the use case 1, and may be rewritten by commands sent from the control apparatus 1100 depending on other use cases.

In FIG. 6, when the camera installation direction is the normal direction, the limitations (proper range) of the vertical tilt angle is 0˜15 degrees and the limitations (proper range) of the horizontal tilt angle is 0 degrees.

In the use case 1, by applying the up tilting between the proper range (0˜15 degrees), it is possible to focus at both near and distance. H ere, plus degree corresponds to the up tilting and minus degree corresponds to the down tilting.

And when the camera installation direction is the reverse direction in the use case 1, the limitations (proper range) of the vertical tilt angle is −15˜0 degrees, which is the down tilting, and the limitations (proper range) of the horizontal tilt angle is 0 degrees.

When the camera installation direction is the direction of right side up in the use case 1, the limitations (proper range) of the horizontal tilt angle is 0˜15 degrees, since the right tilting is proper, and the limitations (proper range) of the vertical tilt angle is 0 degrees. Here, plus degree corresponds to the right tilting and minus degree corresponds to the left tilting.

And when the camera installation direction is the direction of left side up in the use case 1, the limitations (proper range) of the horizontal tilt angle is −15˜0 degrees, since the left tilting is proper, and the limitations (proper range) of the vertical tilt angle is 0 degrees.

As explained in the above, the limitations (proper range) of the tilt angle in this embodiment are so determined that either one of the vertical tilting or the horizontal tilting is exclusively executed.

In addition, although the limitations (proper range) of the tilt angle in this embodiment are between −15˜15 degrees, the limitations (proper range) of the tilt angle may be −10˜10 degrees or, for example, −3˜15 degrees. In this connection, if the limitations (proper range) of the tilt angle is, for example, asymmetric such as −3˜15 degrees and if it is out of camera s mechanical movable range, it is preferable to display a warning on the display unit 1102.

In step S4003, the image sensor control unit 1009 determines to set the limitations of the tilt angle according to the instruction issued from the system control unit 1003.

That is, the image sensor control unit 1009 determines the limitations (proper range) of the tilt angle and based on the determination, sets the limitations of the tilt angle. For example, if the camera installation direction is the normal direction in the step S4001, and the limitations (proper range) of the tilt angle is 0˜15 degrees in a vertical direction and 0 degrees in a horizontal direction in the step S4002, then the image sensor control unit 1009 determines the limitations (proper range) of the tilt angle to 0˜15 degrees in a vertical direction and 0 degrees in a horizontal direction, and set the limitations of the tilt angle accordingly.

In this embodiment, unless a current tilt angle is within the limitations (proper range) of the tilt angle, the image sensor control unit 1009 drive the image sensor to reset the tilt angle to 0 degrees. If the current tilt angle is within the limitations (proper range) of the tilt angle, the image sensor control unit 1009 does not change the current tilt angle of the image sensor.

However, in the step S4003, without regard to whether the current tilt angle is within the limitations (proper range) of the tilt angle or not, the image sensor control unit 1009 may drive the image sensor to reset the tilt angle to 0 degrees, so that in step S4004, the image sensor control unit 1009 can adjust the tilt angle always in a predetermined direction.

In the step S4004, the system control unit 1103 of the control apparatus 1100 sends a command for requesting information on the limitations of the tilt angle set by the image sensor control unit 1009 in the step S4003, to the surveillance camera 1000 through the transmission unit 1101. Then, the system control unit 1103 of the control apparatus 1100 acquires the information on the limitations of the tilt angle and on a current tilt angle of the surveillance camera 1000.

Then, the system control unit 1103 of the control apparatus 1100 renews the tilt angle within the limitations of the tilt angle, when necessary, based on the information on the limitations of the tilt angle and on a current tilt angle of the surveillance camera 1000 obtained in the step S4004.

For that purpose, the system control unit 1103 of the control apparatus 1100 sends necessary commands to the surveillance camera 1000 through the transmission unit 1101.

In response to the above commands received from the system control unit 1103 of the control apparatus 1100, the surveillance camera 1000 controls the image sensor control unit 1009 to execute changing of the tilt angle.

More precisely, by set new tilt angle in the image sensor control unit 1009, the tilt angle is changed.

In this regard, if a user designates in the step S4003, via the control apparatus 1100, a tilt angle out of the limitations of the tilt angle, an angle within the limitations and nearest to the tilt angle designated by the user is alternatively set.

Therefore, when a user manually designates the tilt angle via the control apparatus 1100, the user does not need to try to search proper tilt angle for proper focusing, so that an operation time for the tilt angle can be shortened and unintentional changing to an improper tilt angle can be avoided.

In this regards, although manual operations for changing the tilt angle are explained in the step S4004, an automatic operation for controlling the tilt angle can may be utilized.

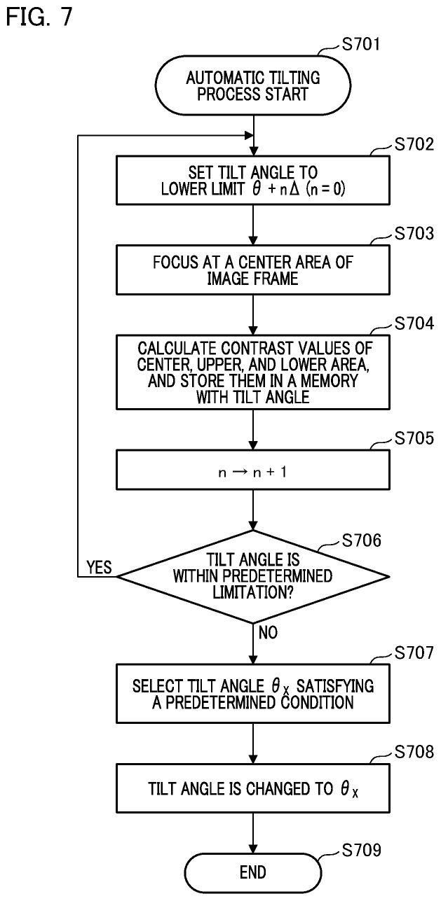

FIG. 7 is a flowchart illustrating the automatic operation for controlling the tilt angle according to the embodiment.

In FIG. 7, the automatic operation process for controlling the tilt angle starts in step S701, when the system control unit 1103 of the control apparatus 1100 sends a command for an automatic tilting to the surveillance camera 1000 through the transmission unit 1101. Then, in step S702, the system control unit 1103 set a tilt angle to :+n∀, which is a lower limit of the tilt angle stored in the limitation data memory 1016 as a part of the information on the limitations of the tilt angle.

Here, ∀ is an angle that is, for example ⅕ of the proper range of the tilt angle, and n is an integer, which is initially 0 in the step S702.

Next, in step S703, the system control unit 1003 instructs the focus control unit 1007 to focus at a center area of an image frame based on contrast information of the video data obtained from the image processing unit 1002.

Then, in step S704, the system control unit 1003 calculates contrast values of the video date in the center area, an upper area, and a lower area of the image frame, and stores them in a memory together with the tilt angle at that ti me.

And in step S705, n is incremented by 1, then in step S706, the system control unit 1003 determines whether the tilt angle is within the predetermined limitations of the tilt angle.

If the tilt angle is within the predetermined limitations of the tilt angle, then the process returns to the step S702, and the steps S702 to S706 are cyclically repeated until the tilt angle exceeds the predetermined limitations of the tilt angle.

By repeating the above steps S702 to S706, table data is obtained that includes plural sets of the contrast values of the center area, an upper area, and a lower area of the image frame, each set corresponding to respective one of the tilt angles.

When the tilt angle exceeds the predetermined limitations of the tilt angle in the step S706, the process proceeds to step S707. In the step S707, one of the tilt angles, which is dubbed :x, that corresponds to one of the sets of the contrast values is selected based on the following condition.

The condition is, for example, that the contrast value of the center area of the set of contrast values is above a predetermined value, and a maximum difference of the contrast values among the center area, an upper area, and a lower area of the image frame within the set of contrast values is minimum compared to those of the other sets of contrast values.

However, the condition may be, for example, that the contrast value of the center area of the set of contrast values is maximum compared to those of the other sets of contrast values, and a maximum difference of the contrast values among the center area, an upper area, and a lower area of the image frame within the set of contrast values is above a predetermined value.

Next, in step S708, :x obtained in S707 is supplied to the image sensor control unit 1009 so that the tilt angle is changed to :x, then in step S709, the flow ends.

Since the automatic operation process in FIG. 7 also uses the data relating to limitations corresponding to each of installation directions, which is stored in the limitation data memory 1016, users do not need to try to search proper tilt angle for proper focusing so that an operation time for the tilt angle can be shortened and unintentional changing to an improper tilt angle can be avoided.

It should be noted that, although the tilt angle of only the image sensor is changed in the present embodiment, the tilt angle of a part of the optical lens may be alternatively changed, or angles of both of the image sensor and the part of the optical lens may be changed.

In addition, while the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention can be realized in processes in which a program that executes one or more functions of the above embodiment is supplied to a system or a device through a network or a storage medium, and one or more processors in a computer of the system or the device read and execute the program. In addition, the present invention can be realized by a circuit (for example, an ASIC) that implements one or more functions.

This application claims the benefit of Japanese Patent Application No. 2018-228701, filed on Dec. 6, 2018, which is hereby incorporated by reference herein in its entirety.

What is claimed is:

1. An imaging control apparatus that controls an imaging apparatus including an imaging unit for taking an object image through an optical system, comprising:
a controller having a processor which executes instructions stored in a memory or having circuitry, the controller being configured to function as:
a tilt control unit configured to control a tilt angle between the imaging unit and the optical system;
a determination unit configured to determine an installation direction of the imaging apparatus;
a data storage unit configured to store information relating to a limitation of the tilt angle corresponding to respective installation direction of the imaging apparatus; and
wherein the tilt control unit limits the tilt angle based on the installation direction of the imaging apparatus acquired by the determination unit and the information relating to the limitation of the tilt angle corresponding to respective installation direction of the imaging apparatus stored in the data storage unit.

2. The imaging control apparatus according to claim 1, wherein the determination unit determines the installation direction of the imaging apparatus based on a predetermined value for designating an inversion process of video data output from the imaging unit.

3. The imaging control apparatus according to claim 1, wherein the determination unit recognizes a direction of an object in video data output from the imaging unit by an image recognition, and determines the installation direction of the imaging apparatus based on the direction of the object recognized by the image recognition.

4. The imaging control apparatus according to claim 1, wherein the determination unit determines the installation direction of the imaging apparatus based on an output from a gravity sensor included in the imaging apparatus.

5. The imaging control apparatus according to claim 1, wherein the tilt control unit resets the tilt angle to a predetermined initial degree, before changing the tilt angle to a tilt angle designated by a user.

6. The imaging control apparatus according to claim 1, wherein the tilt control unit controls the tilt angle by rotating the imaging unit.

7. The imaging control apparatus according to claim 1, wherein the tilt control unit controls the tilt angle by rotating a part of the optical system.

8. The imaging control apparatus according to claim 1, wherein the tilt control unit automatically controls the tilt angle based on video data output from the imaging unit.

9. The imaging control apparatus according to claim 8, wherein the tilt control unit compares contrast values of different areas of an image frame while changing the tilt angle.

10. The imaging control apparatus according to claim 8, wherein the tilt control unit select a nearest tilt angle within the limitation, which is the nearest to a designated tilt angle, in a case the designated tilt angle is out of the limitation.

11. The imaging control apparatus according to claim 1, wherein the tilt angle is an angle of the imaging unit with respect to a plane perpendicular to an optical axis of the optical system.

12. An imaging control method for controlling an imaging apparatus including an imaging unit for taking an object image through an optical system, comprising:
controlling a tilt angle between the imaging unit and the optical system;
determining an installation direction of the imaging apparatus;
storing information relating to a limitation of the tilt angle corresponding to respective installation direction of the imaging apparatus; and
wherein the controlling includes limiting the tilt angle based on the installation direction of the imaging apparatus determined by the determining and the information relating to the limitation of the tilt angle corresponding to respective installation direction of the imaging apparatus stored in the storing.

13. A non-transitory computer-readable storage medium storing a program for causing a computer to execute an imaging control method for controlling an imaging apparatus including an imaging unit for taking an object image through an optical system, wherein the imaging control method comprising:
control ling a tilt angle between the imaging unit and the optical system;
determining an installation direction of the imaging apparatus;
storing information relating to a limitation of the tilt angle corresponding to respective installation direction of the imaging apparatus; and
wherein the controlling limits the tilt angle based on the installation direction of the imaging apparatus determined by the determining and the information relating to the limitation of the tilt angle corresponding to respective installation direction of the imaging apparatus stored in the storing.
